(19) United States
(12) Patent Application Publication
(10) Pub. No.: US 2024/0089404 A1
(43) Pub. Date: Mar. 14, 2024

(54) SYSTEMS AND METHODS FOR REAL-TIME ONLINE USER INTERACTION WITH ATHLETES

(71) Applicant: Fansview Inc., White Plains, NY (US)

(72) Inventors: Anton Rukaj, White Plains, NY (US); Agim Lolovic, Old Greenwich, CT (US)

(21) Appl. No.: 18/462,737

(22) Filed: Sep. 7, 2023

Related U.S. Application Data
(60) Provisional application No. 63/404,831, filed on Sep. 8, 2022.

(51) Int. Cl. H04N 7/14; G06Q 30/08; H04N 7/15

(52) U.S. Cl. CPC H04N 7/147; G06Q 30/08; H04N 7/155

(57) ABSTRACT

A system for real-time online user interaction with an athlete, includes a processor and a memory. The memory includes instructions stored thereon, which, when executed by the processor, cause the system to: access a plurality of questions; group the plurality of questions into a plurality of groups of questions that include the same topic relating to an athlete of the sporting event; sort the plurality of groups of questions based on which of the plurality of groups of questions have the largest quantity of questions; access an end time of a sporting event; determine if the sporting event has ended based on the end time; and transmit the group of questions that includes the largest quantity of questions to the athlete in response to the sporting event ending.

### CROSS-REFERENCE TO RELATED APPLICATIONS

This application claims the benefit of, and priority to, U.S. Provisional Patent Application No. 63/404,831, filed on Sep. 8, 2022, the entire contents of which are hereby incorporated herein by reference.

### TECHNICAL FIELD

The present disclosure relates generally to the field of multimedia communications. More specifically, an aspect of the present disclosure provides systems and methods for real-time online user interaction with athletes.

### BACKGROUND

In the typical interview medium, athletes are consistently asked impersonal, repetitive, and inciting questions that dilute the value of the content. Frustrated with typical interview formats and mandates, athletes inadvertently become disengaged from their fans. Fan are treated as mere consumers of interview content, without any influence in content creation. In turn, fans become disengaged from their favorite athletes and often succumb to diluted media driven clickbait.

Accordingly, there is interest in improving interviews of athletes.

### SUMMARY

In accordance with aspects of this disclosure, a system for real-time online user interaction with an athlete is presented. The system includes a processor and a memory. The memory includes instructions stored thereon, which, when executed by the processor, cause the system to: access a plurality of questions; generate a new question based on the plurality of questions; access an end time of the sporting event; determine if the sporting event has ended based on the end time; and transmit the new question to the athlete in response to the sporting event ending.

In an aspect of the present disclosure, when generating a new question based on the plurality of questions, the instructions, when executed by the processor, may further cause the system to: receive as an input to a machine learning model the plurality of questions; assign a first score, by the machine learning model to each question of the plurality of questions based on how related each of the plurality of questions are to one another; generate, by the machine learning model, the new question based on a subset of the plurality of questions, where the subset includes questions that have a score over a threshold value; and assign a second score to the new question based on how many questions of the plurality of questions make up the subset of the plurality of questions.

In another aspect of the present disclosure, when transmitting the new question to the athlete, the instructions, when executed by the processor, may further cause the system to transmit the new question to the athlete in response to the sporting event ending based on the second score.

In yet another aspect of the present disclosure, the machine learning model may include natural language processing.

In a further aspect of the present disclosure, the instructions, when executed by the processor, may further cause the system to filter the plurality of questions for profanity and remove questions from the plurality of questions that include profanity in response to the filtering.

In yet a further aspect of the present disclosure, when generating a new question based on the plurality of questions, the instructions, when executed by the processor, may further cause the system to: group the plurality of questions into a plurality of groups of questions that include a same topic relating to an athlete of the sporting event, where in the plurality of questions in each are topically related to one another; and sort the plurality of groups of questions based on which of the plurality of groups of questions have the largest quantity of questions.

In an aspect of the present disclosure, the instructions, when executed by the processor, may further cause the system to generate a new question based on the group of questions that includes the largest quantity of questions to the athlete in response to the sporting event ending.

In another aspect of the present disclosure, the instructions, when executed by the processor, may further cause the system to transmit the new question to the athlete in response to the sporting event ending and a number of votes.

In yet another aspect of the present disclosure, the instructions, when executed by the processor, may further cause the system to receive a number of votes for each group of the plurality of groups of questions.

In a further aspect of the present disclosure, the instructions, when executed by the processor, may further cause the system to generate a new question based on the group of questions that includes the largest number of votes in response to the sporting event ending.

In accordance with aspects of this disclosure, a computer-implemented method for real-time online user interaction with an athlete is presented. The method includes accessing a plurality of questions; generating a new question based on the plurality of questions; accessing an end time of the sporting event; determining if the sporting event has ended based on the end time; and transmitting the new question to the athlete in response to the sporting event ending.

In yet another aspect of the present disclosure, the method may further include receiving as an input to a machine learning model the plurality of questions; assigning a first score, by the machine learning model to each question of the plurality of questions based on how related each of the plurality of questions are to one another; generating by the machine learning model, the new question based on a subset of the plurality of questions, where the subset includes questions that have a score over a threshold value; and assigning a second score to the new question based on how many questions of the plurality of questions make up the subset of the plurality of questions.

In a further aspect of the present disclosure, transmitting the new question to the athlete may include transmitting the new question to the athlete in response to the sporting event ending based on the second score.

In yet a further aspect of the present disclosure, the machine learning model includes natural language processing.

In an aspect of the present disclosure, the method may further include filtering the plurality of questions for profanity; and removing questions from the plurality of questions that include profanity in response to the filtering.

In another aspect of the present disclosure, the method may further include grouping the plurality of questions into a plurality of groups of questions that include a same topic relating to an athlete of the sporting event; and sorting the plurality of groups of questions based on which of the plurality of groups of questions have the largest quantity of questions. The plurality of questions in each may be topically related to one another.

In yet another aspect of the present disclosure, the method may further include generating a new question based on the group of questions that includes the largest quantity of questions to the athlete in response to the sporting event ending.

In a further aspect of the present disclosure, the method may further include transmitting the new question to the athlete in response to the sporting event ending and a number of votes.

In a further aspect of the present disclosure, the method may further include receiving a number of votes for each group of the plurality of groups of questions; and generating a new question based on the group of questions that includes the largest number of votes to the athlete in response to the sporting event ending.

In accordance with aspects of this disclosure, a system for real-time online user interaction with an athlete, that includes a processor and a memory. The memory includes instructions stored thereon, which, when executed by the processor, cause the system to: access a bid from a plurality of users including a first user and a second user; confirm plurality of users are authenticated users; compare a first bid from the first user to a second bid of the second user to determine a winning user based on the larger of the first bid or the second bid; transmit instructions for live interview and a link for an interview preparation video to the winning user; transmit a prompt to request a question to be asked to the athlete; receive the question to be asked to the athlete; compare the question passes a set of rules; and in a case where the question fails the set of rules then provide an indication to the winning user that the question fails and repeat transmitting the prompt to request a new question to be asked to the athlete. In a case where the question passes the set of rules then the instructions, when executed by the processor cause the system to: provide an indication to the winning user that the question passes; provide a link to enter the interview room; and start the live interview with the athlete.

The details of one or more aspects of this disclosure are set forth in the accompanying drawings and the description below. Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a diagram illustrating an exemplary screenshot from a system for real-time online user interaction with an athlete, in accordance with aspects of the present disclosure;

FIG. 2 is a block diagram of a controller configured for use with the system of FIG. 1, in accordance with aspects of the disclosure;

FIG. 3 is a flow diagram of a computer-implemented method for real-time online user interaction with an athlete, in accordance with aspects of the present disclosure;

FIG. 4 is an example screenshot of an athlete profile banner, in accordance with aspects of the disclosure;

FIG. 5 is an example screenshot of an athlete profile page, in accordance with aspects of the disclosure;

FIG. 6 is an example screenshot of an audience view of an interview, in accordance with aspects of the disclosure;

FIG. 7 is an example screenshot of an event browsing screen, in accordance with aspects of the disclosure;

FIG. 8 is an example screenshot of a weekly top fan breakdowns screen, in accordance with aspects of the disclosure;

FIG. 9 is an example screenshot of an unavailable fan breakdown screen, in accordance with aspects of the disclosure;

FIG. 10-12 are example screenshots of an event chat screen, in accordance with aspects of the disclosure;

FIG. 13 is an example screenshot of an interview home screen, in accordance with aspects of the disclosure;

FIG. 14 is an example screenshot of joining an event chat screen, in accordance with aspects of the disclosure;

FIG. 15 is an example screenshot of a live interview screen, in accordance with aspects of the disclosure;

FIG. 16 is an example screenshot of an interview removal notification, in accordance with aspects of the disclosure;

FIG. 17 is an example screenshot of a fan profile screen, in accordance with aspects of the disclosure;

FIG. 18 is an example screenshot of a team search window, in accordance with aspects of the disclosure;

FIG. 19 is an example screenshot of a search results window, in accordance with aspects of the disclosure;

FIG. 20 is an example screenshot of an interview completion alert, in accordance with aspects of the disclosure;

FIG. 21 is an example screenshot of a daily interviews home screen, in accordance with aspects of the disclosure;

FIG. 22 is an example screenshot of a bid placing screen, in accordance with aspects of the disclosure;

FIG. 23 is an example screenshot of a bid entry screen, in accordance with aspects of the disclosure;

FIG. 24 is an example screenshot of an auction end alert, in accordance with aspects of the disclosure;

FIG. 25 is an example screenshot of a bid amount notice screen, in accordance with aspects of the disclosure;

FIG. 26 is an example screenshot of payment error screen, in accordance with aspects of the disclosure;

FIG. 27 is an example screenshot of an auction winning alert screen, in accordance with aspects of the disclosure;

FIG. 28 is an example screenshot of a winning auction instructions screen, in accordance with aspects of the disclosure;

FIG. 29 is an example screenshot of a question submission screen, in accordance with aspects of the disclosure;

FIG. 30 is an example screenshot of an opening fan question voting alert screen, in accordance with aspects of the disclosure;

FIG. 31 is an example screenshot of an active fan question voting screen, in accordance with aspects of the disclosure;

FIG. 32 is an example screenshot of a successful question submission alert screen, in accordance with aspects of the disclosure;

FIG. 33 is an example screenshot of a questions pending review alert screen, in accordance with aspects of the disclosure;

FIG. 34 is an example screenshot of an alternate home page questions pending review screen, in accordance with aspects of the disclosure;

FIG. 35 is an example screenshot of a rejected questions resubmission screen, in accordance with aspects of the disclosure;

FIG. 36 is an example screenshot of an alternate home page rejected questions alert screen, in accordance with aspects of the disclosure;

FIG. 37 is an example screenshot of an interview prep video screen, in accordance with aspects of the disclosure;

FIG. 38 is an example screenshot of an interview start countdown screen, in accordance with aspects of the disclosure;

FIG. 39 is an example screenshot of a home page interview entrance screen, in accordance with aspects of the disclosure;

FIG. 40 is an example screenshot of a trending interviews screen, in accordance with aspects of the disclosure; and

FIG. 41 is an example screenshot of an upcoming interviews screen, in accordance with aspects of the disclosure.

Further details and aspects of exemplary aspects of the disclosure are described in more detail below with reference to the appended figures. Any of the above aspects and aspects of this disclosure may be combined without departing from the scope of the disclosure.

### DETAILED DESCRIPTION

The present disclosure relates generally to the field of multimedia communications. More specifically, an aspect of the present disclosure provides systems and methods for real-time online user interaction with athletes.

Although this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the inventive features illustrated herein, and any additional applications of the principles of this disclosure, as illustrated herein, which would occur to one skilled in the relevant art and having possession of this disclosure, are to be considered within the scope of this disclosure.

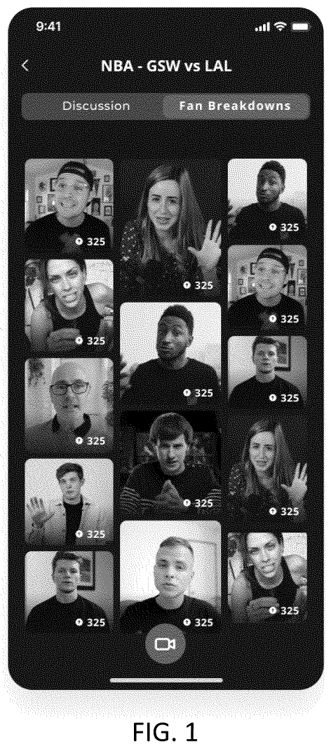

Referring to FIG. 1, an exemplary screenshot of a system for real-time online user interaction with an athlete is shown. The disclosed systems (e.g., smartphone and app) and corresponding methods may be used, for example, for bidding to interview an athlete after a game, for enabling a user to record their own 30-60 second analysis of the game, and/or for posting to a community page for voting each week, in which the top voted fan breakdown could earn a free interview with a famous athlete. The disclosed systems and methods may further be used, for example, for submitting and voting on questions users want the athlete to answer in the interview, as well as for allowing the user to interview the athlete virtually. Even though athletes are used as an example, the disclosed technology may apply to other fields, such as musicians, celebrities, and/or politicians. Unless indicated otherwise, a disclosure using the term “athlete” shall be treated as and is intended to be treated as a disclosure using the term “musician” or “celebrity” or “politician.”

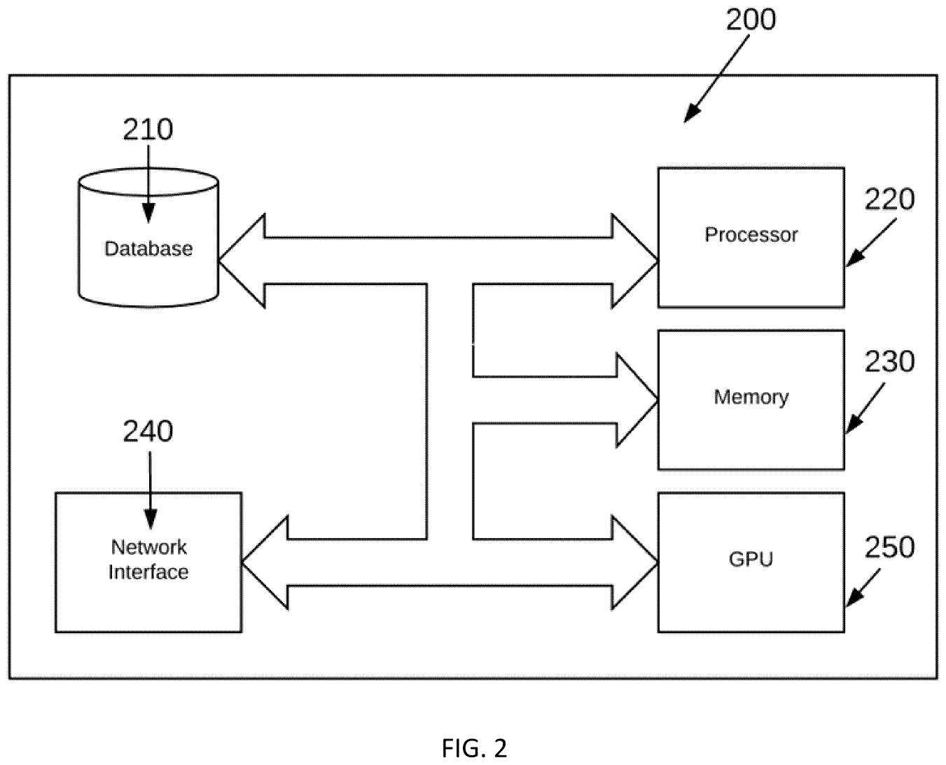

FIG. 2 illustrates an exemplary system 200 that includes a processor 220 connected to a computer-readable storage medium or a memory 230. The system 200 may be the system 100 shown in FIG. 1. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the system 200 and can communicate with the processor 220 through communication buses of a circuit board and/or through communication cables such as serial ATA cables or other types of cables. The memory 230 includes computer-readable instructions that are executable by the processor 220 to operate the system 200. In other aspects of the disclosure, the system 200 may include a network interface 240 to communicate with other computers or to a server (not shown). A storage device 210 may be used for storing data. The disclosed method may run on the system 200 or on a user device, including, for example, on a mobile device, an IoT device, or a server system (not shown).

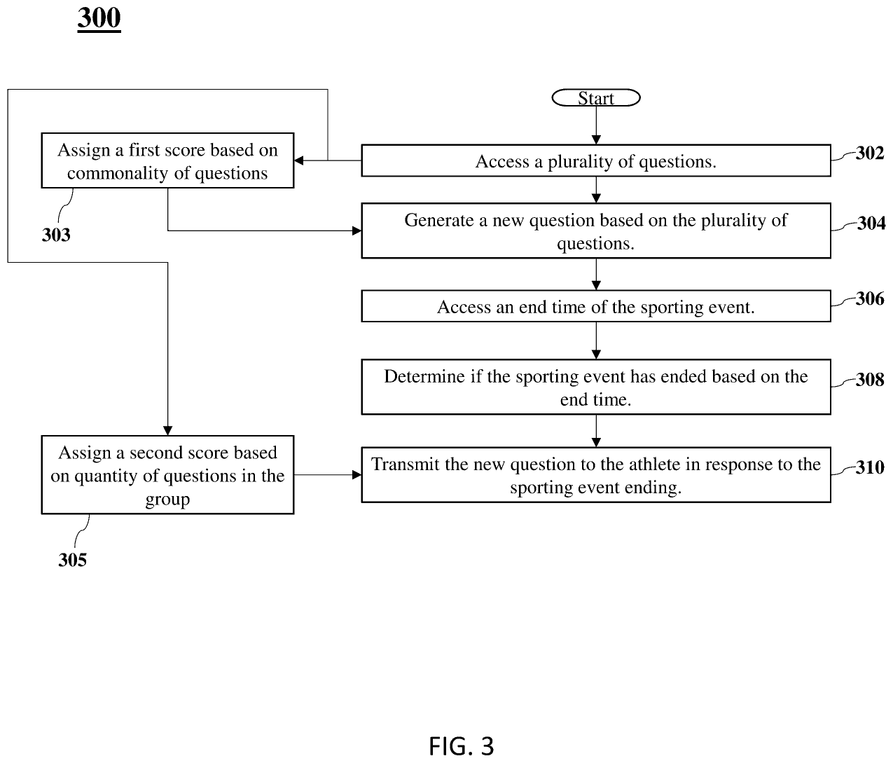

Referring to FIG. 3, a flow diagram for an operation 300 in accordance with aspects of the present disclosure for real-time online user interaction with an athlete is shown. Although the blocks of FIG. 3 are shown in a particular order, the blocks need not all be performed in the illustrated order, and certain blocks can be performed in another order. The operation of FIG. 3 will be described below, and such operation may be performed by the system 200 of FIG. 2. In aspects, the operations of FIG. 3 and/or other disclosed operations may be performed all or in part by another device, for example, a server, a central system, a cloud system a user device, and/or a computer system, among others. These variations are contemplated to be within the scope of the present disclosure.

The user may log in using their email and password. In aspects, the operation 300 may include login persistence.

At block 302, the operation accesses a plurality of questions. For example, a number of users may enter questions for an athlete of a sporting event, during the sporting event. For example, a user question may be “how did it feel to take the game-winning shot against the Bucks?” The operation may utilize event status logic to enable and/or disable functionality on the interview page (e.g., start fan question voting when the sporting event ends). In aspects, the users may vote on questions. The votes may then be received. The operation may count and track question votes so they can be populated into the interviewer's view during the interview.

At block 304, the operation generates a new question based on the plurality of questions. For example, the operation may gather and summarize user's (e.g., fans) questions so the most common questions are identified and a new question is generated based on the most common questions.

In aspects, at block 304, the operation may receive, as an input to a machine learning model, the plurality of questions. The operation may assign a first score by the machine learning model to each question of the plurality of questions based on how related each of the plurality of questions are to one another (block 303). The operation may generate, by the machine learning model, the new question based on a subset of the plurality of questions, where the subset includes questions that have a score over a threshold value. The operation may assign a second score to the new question based on how many questions of the plurality of questions make up the subset of the plurality of questions (block 305). The machine learning model may include natural language processing. In aspects, the operation may filter the plurality of questions for profanity. In aspects, the operation may generate a new question based on the group of questions that includes the largest number of votes in response to the sporting event ending. Although sporting events are used as an example, other types of events are contemplated to be within the disclosure.

At block 306, the operation accesses an end time of the sporting event. At block 308, the operation determines if the sporting event has ended based on the end time.

At block 310, the operation transmits the new question to the athlete in response to the sporting event ending based on the second score.

In aspects, a user may vote to invite an athlete. For example, a user may view an inactive athlete's (and/or entertainer's) profile page and indicate that they would like to see the athlete on the platform. The indication may generate an invitation to the athlete.

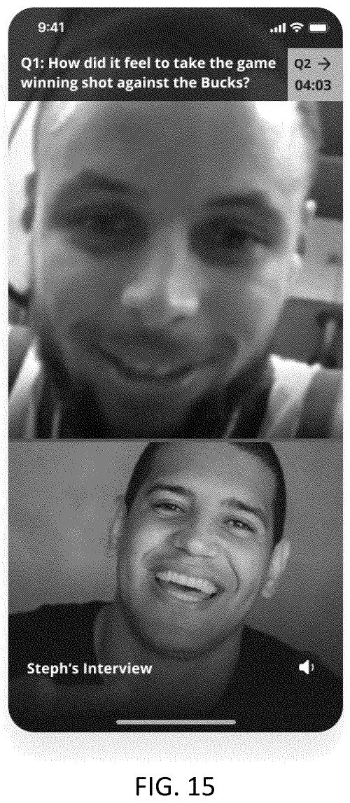

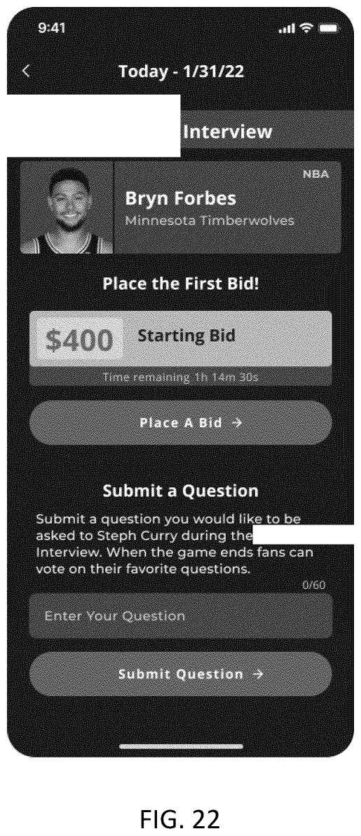

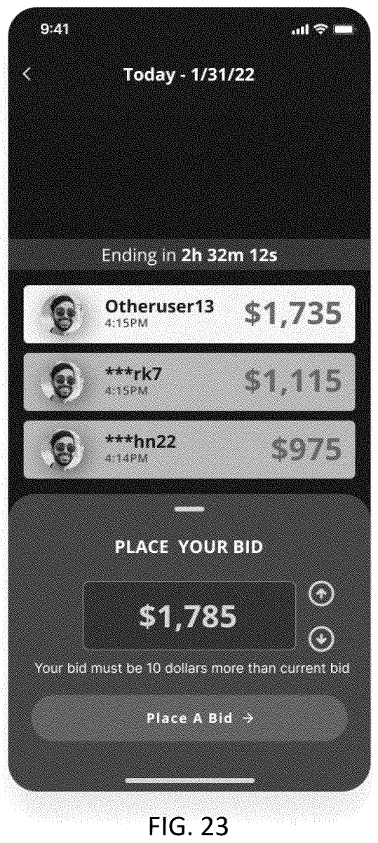

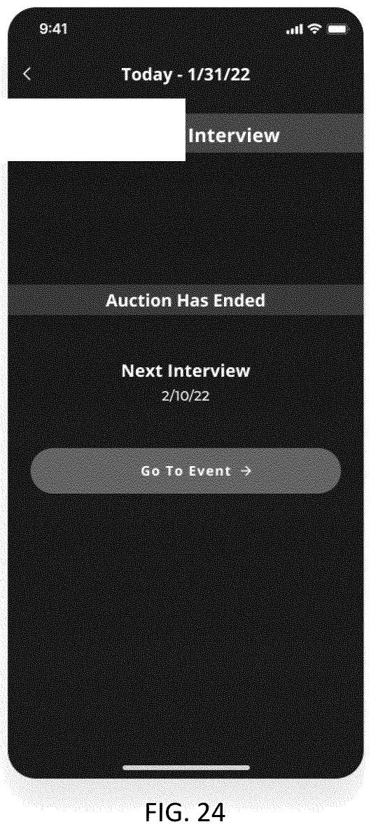

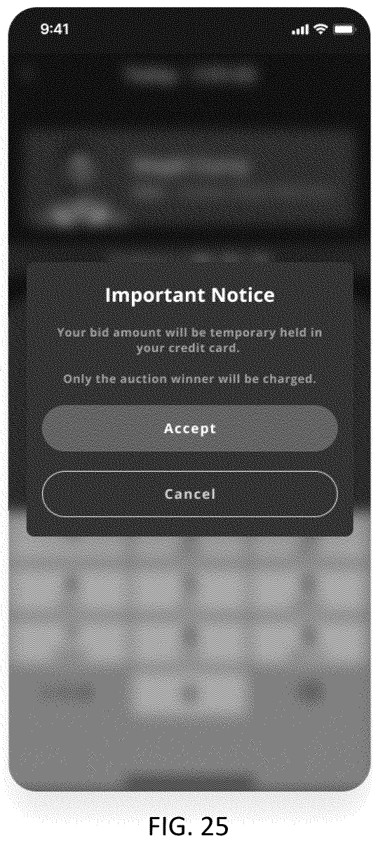

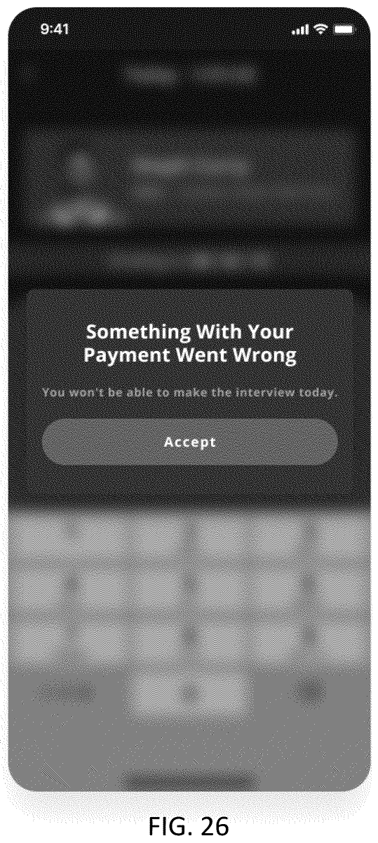

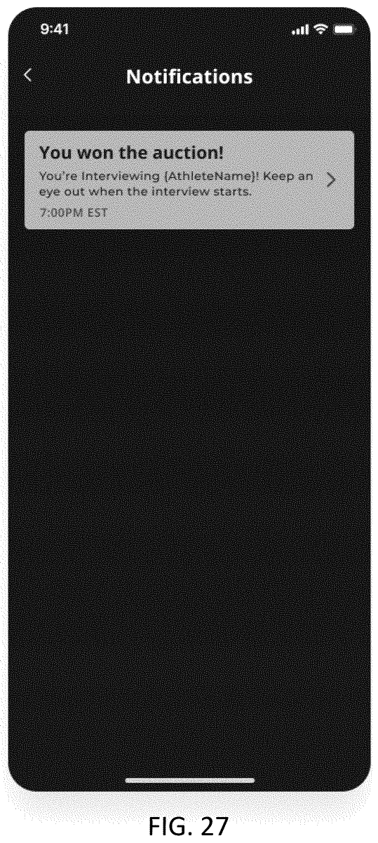

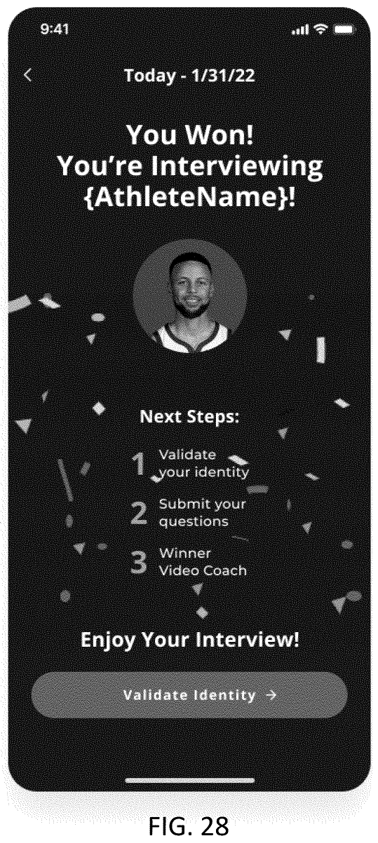

The operation of FIG. 3 is exemplary, and other operations are contemplated. For example, in aspects, the disclosed technology may enable a user to participate in an auction to live interview an athlete (FIG. 15). The operation(s) may access a bid from a plurality of users (FIGS. 22 and 23). The operation(s) may confirm plurality of users are authenticated users. Users that are not authenticated may not participate in the auction. The operation(s) may compare bids from the plurality of users to determine a winning user (FIG. 25). Users may bid until the end of the athletic event (FIG. 24). If there is an error in payment, the user may be notified (FIG. 26). The operation(s) may determine which bidding user is the winning user (FIG. 27) and notify the winning user (FIG. 28).

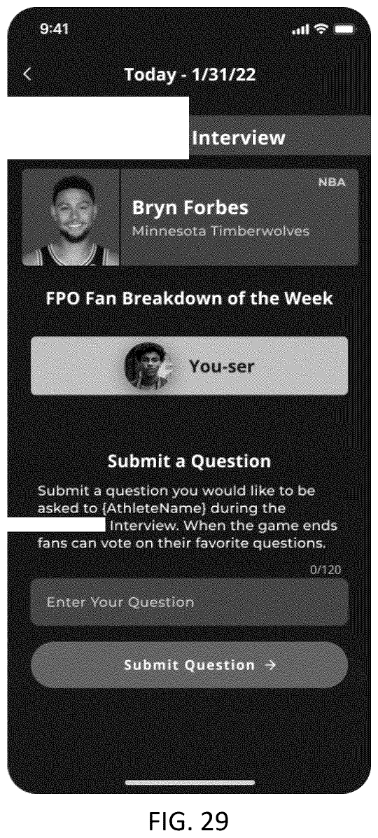

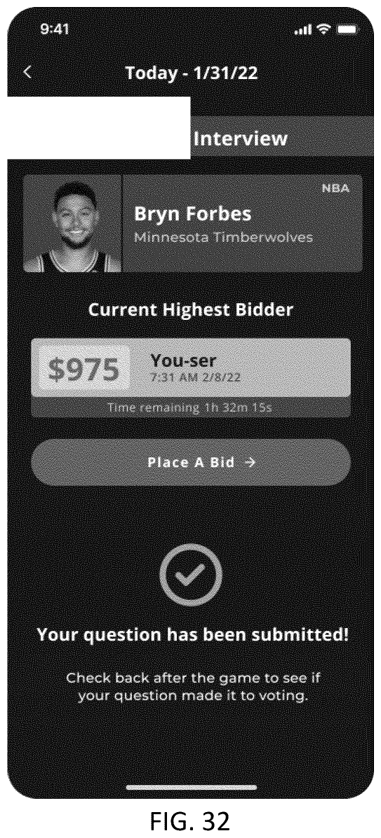

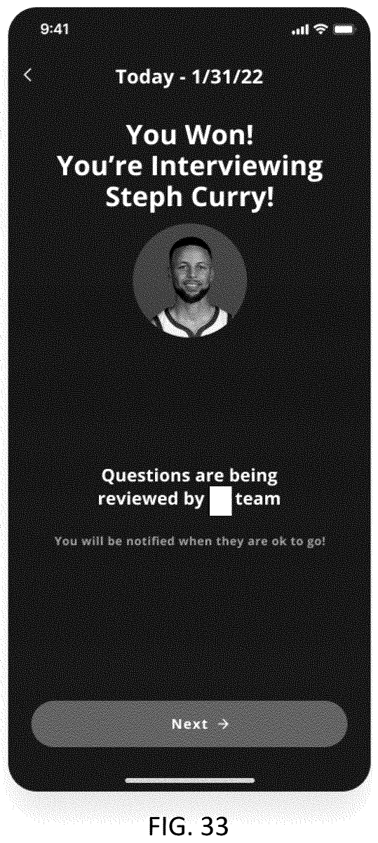

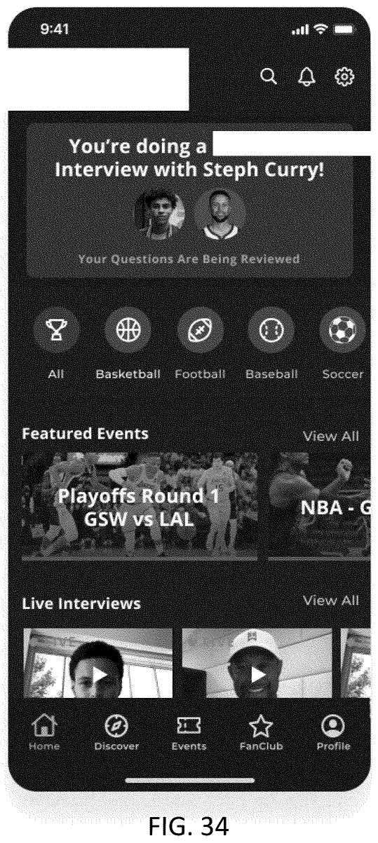

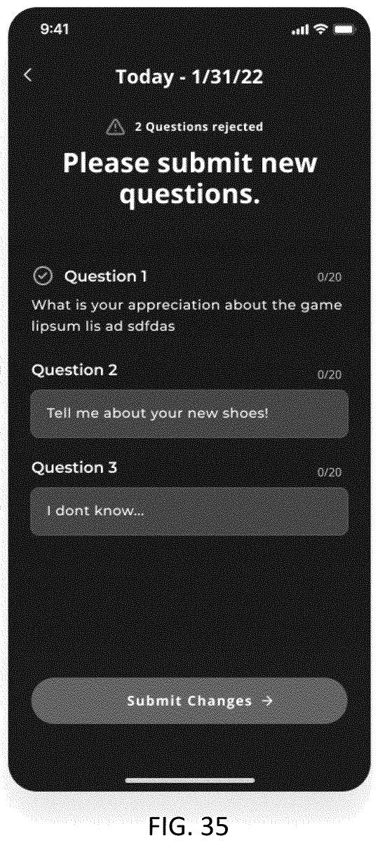

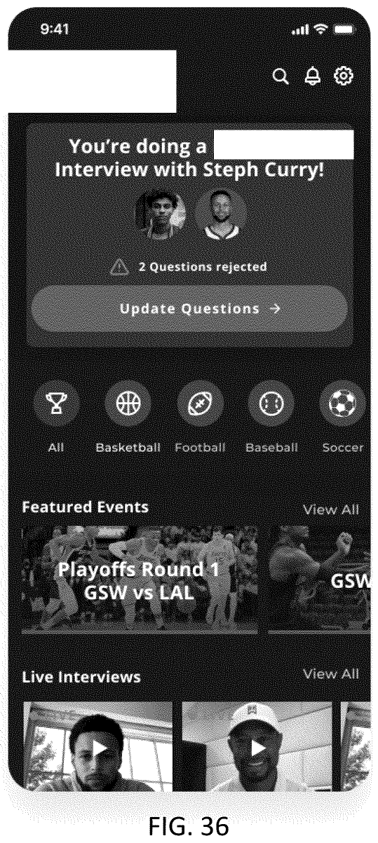

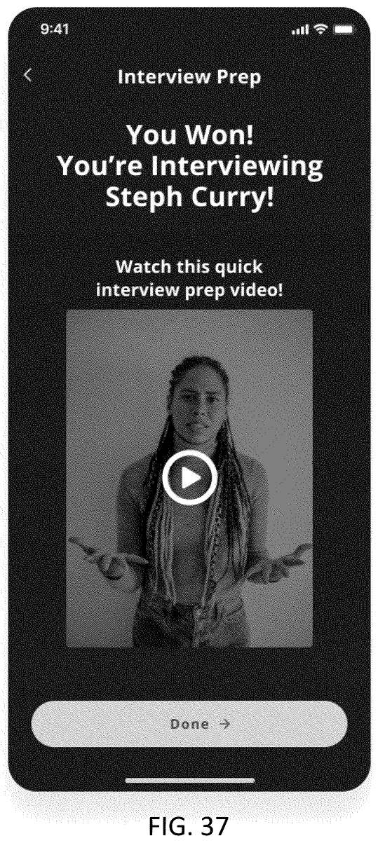

As an example of further operation(s), the operation(s) may transmit instructions for a live interview and a link for an interview preparation video to the winning user. The preparation video may provide the user training to have a good interview (FIG. 37). The winning bidder may submit questions they want to ask the athlete (FIG. 29). The operation(s) may transmit a prompt to request a question to be asked to the athlete. The operation(s) may receive the question to be asked to the athlete and compare the question passes a set of rules. The question may be reviewed by a moderator (FIGS. 33-34). For example, if any of the winner's questions are denied by a moderator, the winner will need to resubmit a new question and restart the review process (FIGS. 35-36). The user may be notified of successful question submission (FIG. 32).

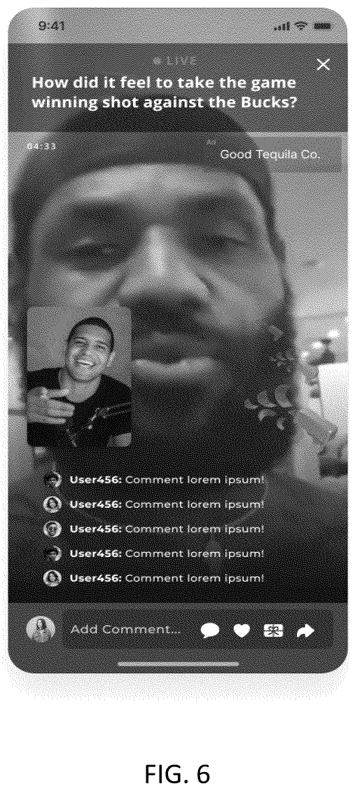

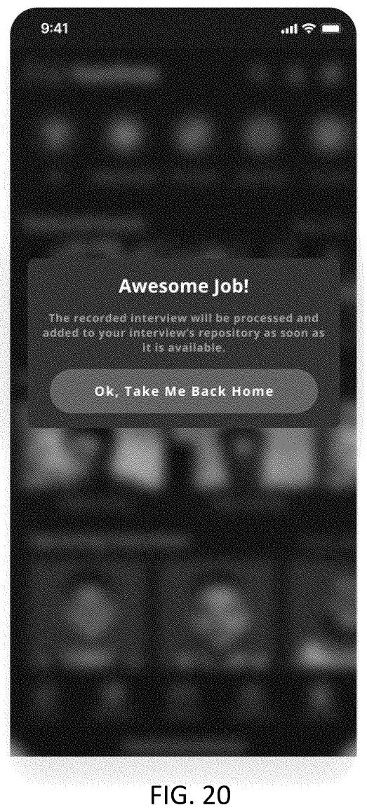

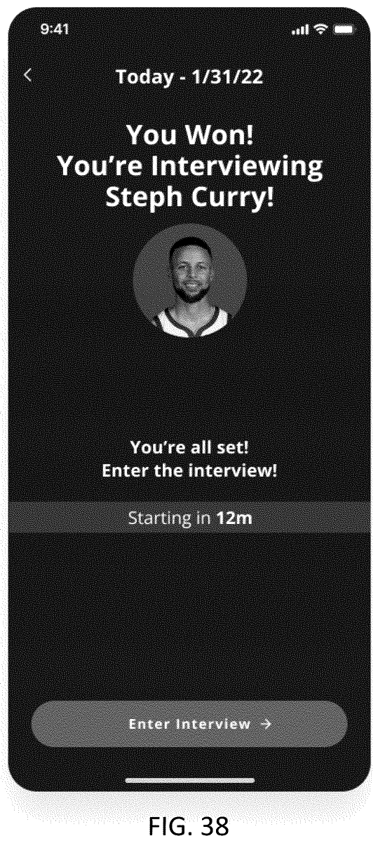

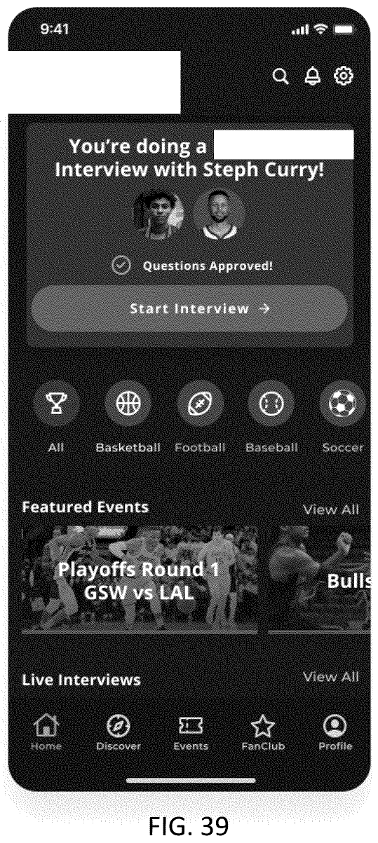

In a case where the question fails the set of rules, the operation(s) may provide an indication to the winning user that the question fails and repeat transmitting the prompt to request a new question to be asked to the athlete. In a case where the question passes the set of rules, the operation(s) may provide an indication to the winning user that the question passes, provide a link to enter the interview room (FIGS. 38-39), and start the live interview with the athlete (FIG. 6). When the interview is complete, the operation(s) may transmit to the user and/or athlete an alert indicating that the interview is complete (FIG. 20).

The disclosed technology may include an auction activity module that displays the auction's status, such as start time or highest bid. The disclosed technology may include a payments/bidding platform to enable users to participate in auctions/enter bids to win, and perform a live interview with an athlete and/or entertainer. The user may be provided a page to see the current bid activity and a link to enter a bid

The operation(s) may provide the status of the winning user's questions so they can be prepared for the interview. The disclosed technology may provide a winner's homepage interview status module. For example, as an auction winner, a module may be provided on a homepage that shows the user the question status as well as a link to join the waiting room when it is available. Other users may watch the live interview (FIG. 6).

In aspects, the athlete (and/or entertainer) may be able to control the interview so they can cut the interviewer's audio, video, or both. The operation(s) may transmit a backup question to the athlete, for example, interview questions from other users that are not the user whose interview was terminated. The disclosed technology may enable an athlete to see the current question on the screen, so if there is bad reception or a language barrier, the question can still get answered. A timer may be displayed to show the athlete and/or the user conducting a live interview how much time is left in the interview. The operation(s) may receive and display comments from other users regarding the live interview.

In aspects, the operation(s) may cause the display of the status of the game. The operation(s) may calculate the status of the game because auctions may depend on start time, and question voting depends on the event end time. The operation(s) may set a notification on the event, such as auction start time, event start time, voting start time, auction end, and/or interview start. The operation(s) may display athlete's pages with interview auctions available after a sporting event with a link to an auction page.

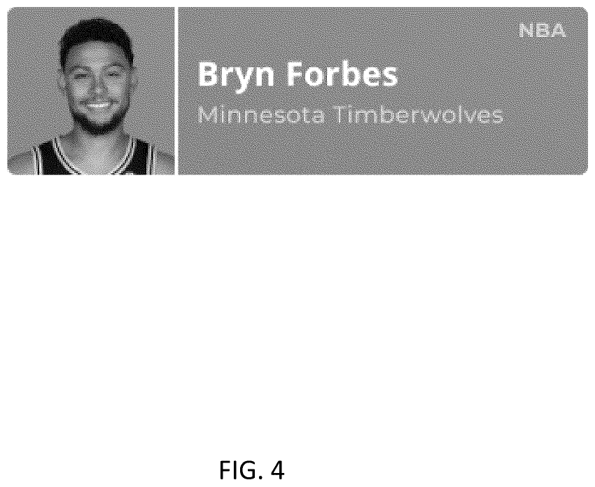

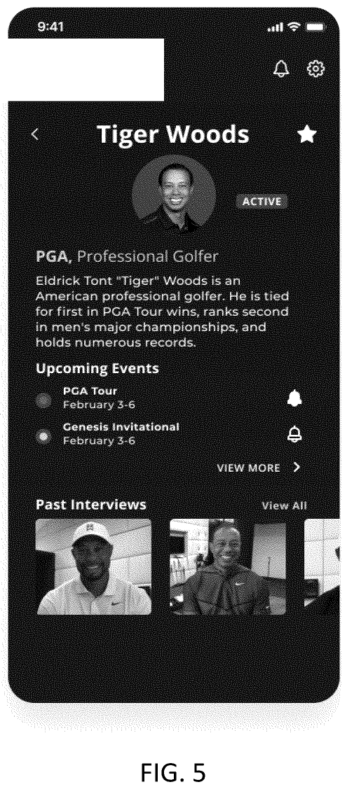

Referring to FIG. 4, an example screenshot of an athlete profile banner is shown. The athlete profile banner may be displayed on various screens, For example, to advertise an athlete. Athletes may have their own profile page (FIG. 5). The Athlete profile page may include information on upcoming events and/or a description of or short bio on the athlete.

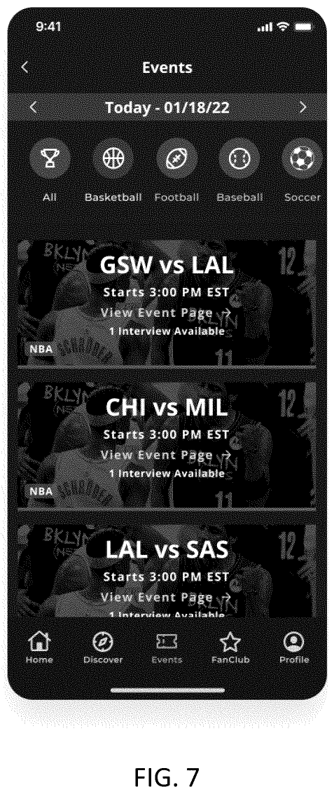

FIG. 7 is an example screenshot of an event detail screen. The disclosed technology enables users to discuss events with a community who is also on the event detail page.

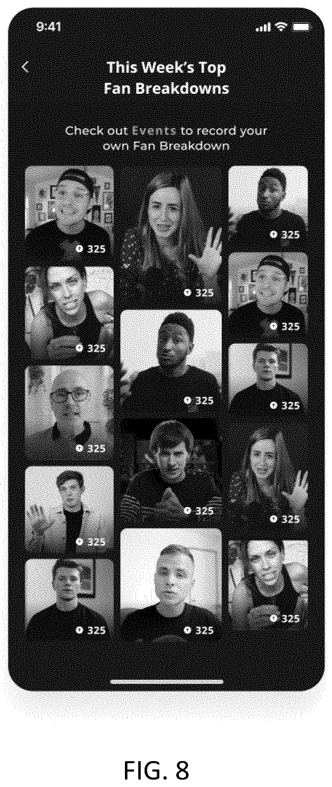

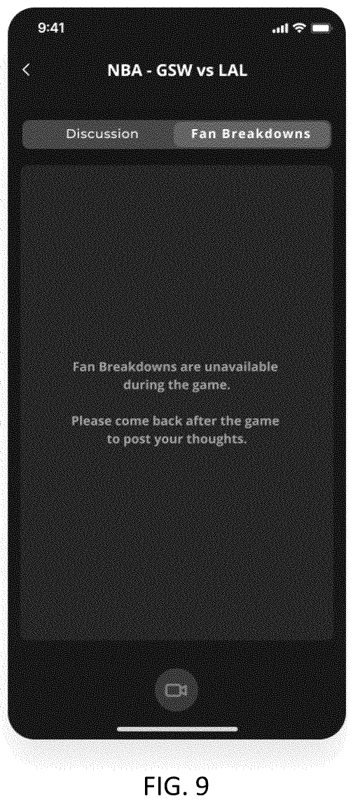

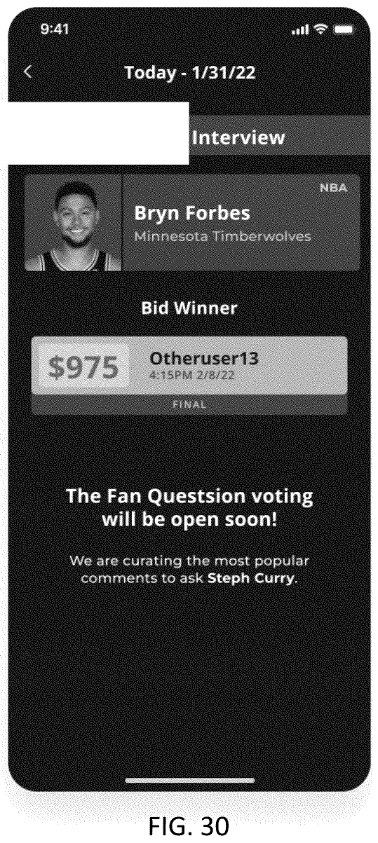

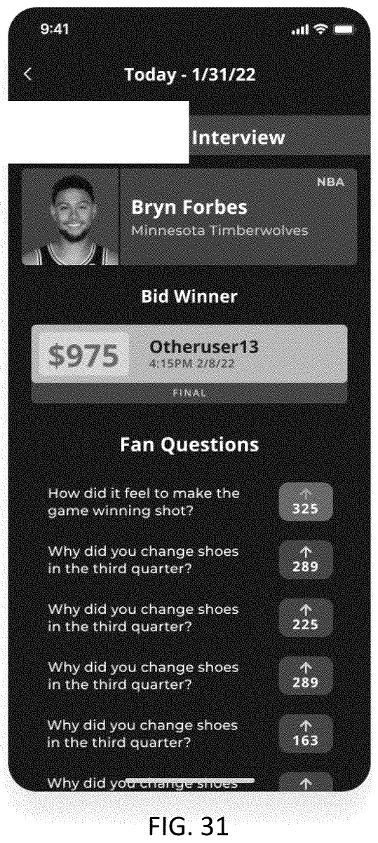

FIGS. 8 and 9 are example screenshots of a weekly top fan breakdowns screen. A user may post a “Fan Breakdown.” For example, a user may post a selfie video of doing a breakdown of the event to the event discussion. The fan breakdown may be limited, for example, to one post per event. In aspects, fan breakdown videos may be displayed for other users to watch. For example, on an event detail page, the fan breakdown videos may be separated out from the chat discussion so that the user can view them with an infinite scroll. The user(s) may see and engage in a discussion tied to a fan breakdown video. User(s) may “Like” a fan breakdown video, so, for example, the fan breakdown video can gain popularity and exposure. The operation(s) may keep track of and display the number of likes a fan breakdown video receives. In aspects, the highest voted fan breakdown may win an interview (FIGS. 30-31). For example, the operation(s) may award the fan with the highest voted fan breakdown of the week with a free interview, or the interview may be assigned by a moderator.

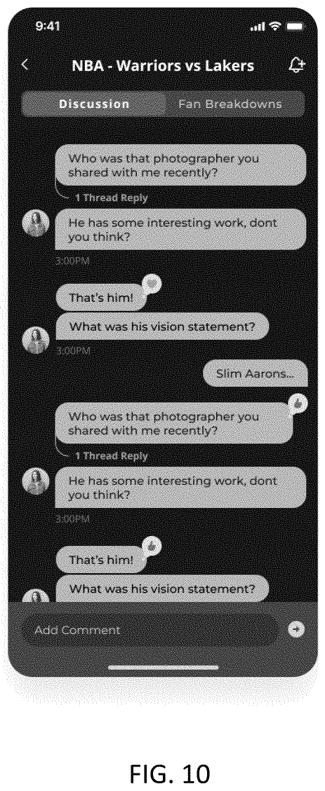

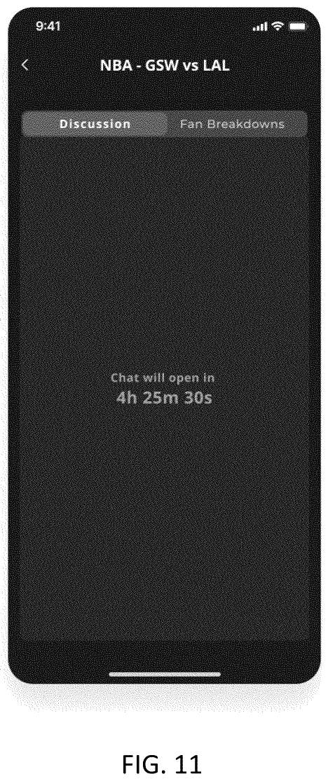

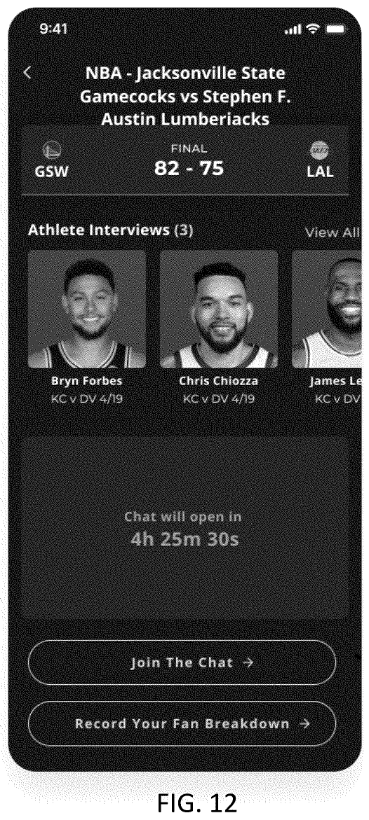

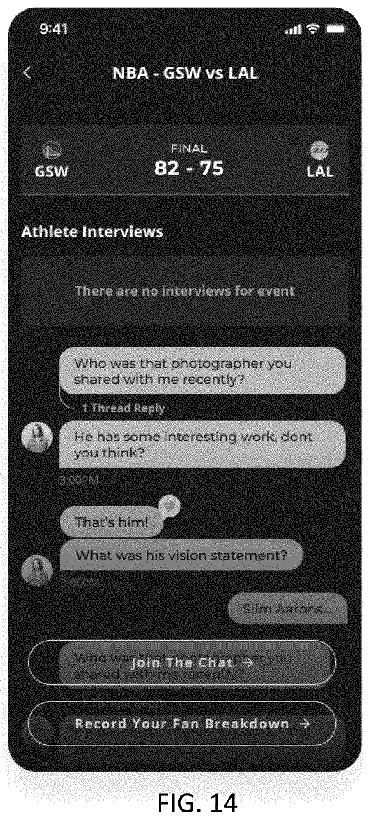

FIGS. 10, 11, 12, and 14 are example screenshots of event chat screens. When chats are not active, a timer may be displayed to indicate when the chat will open. The chat opening time may be triggered by the game start and/or end time.

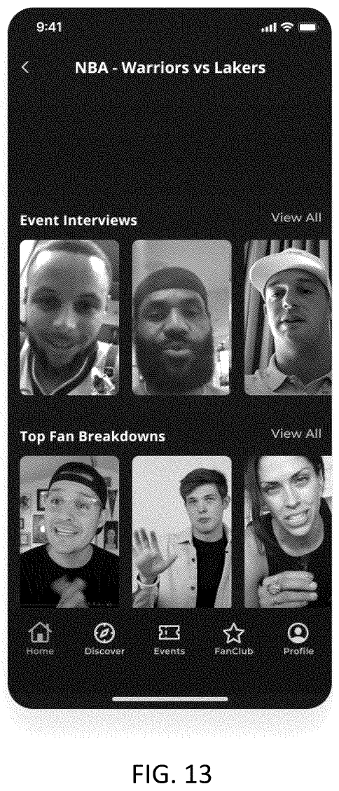

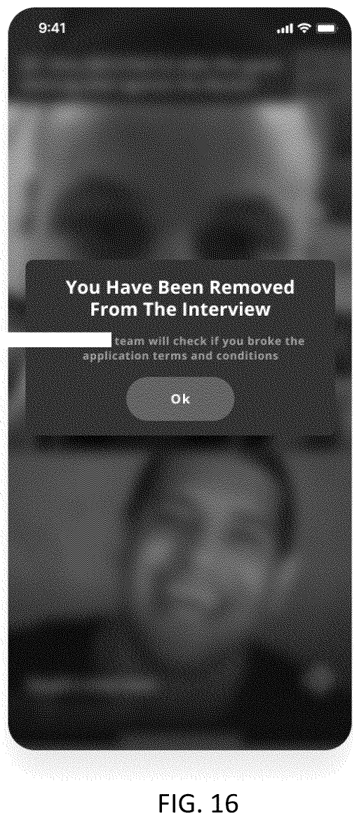

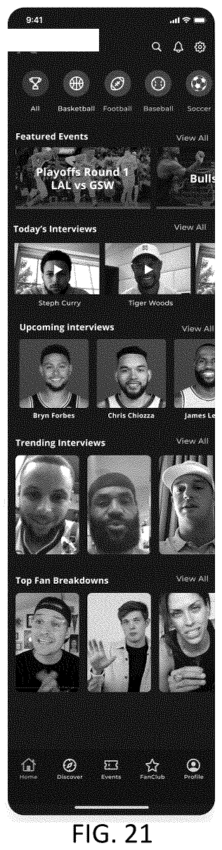

FIGS. 13, 15, 16, 20 and 21 are example screenshots of interview screens. The interview screens may include an interview home screen (FIG. 13), and/or a live interview screen (FIG. 15). The user may receive an interview removal notification (FIG. 16) and/or an interview completion alert (FIG. 20). FIG. 21 shows an example screenshot of a daily interviews home screen, where a user can see what daily interviews are scheduled.

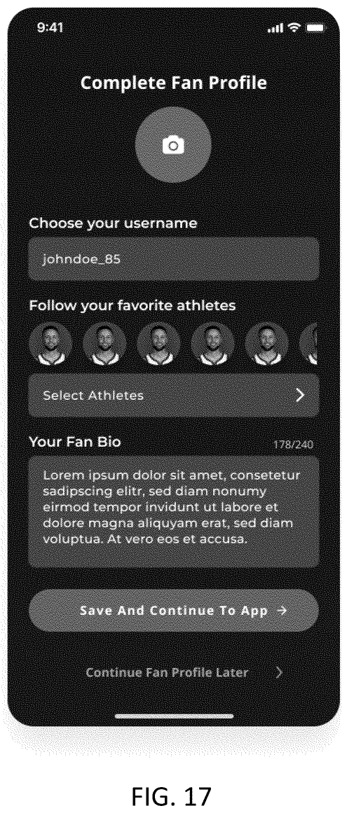

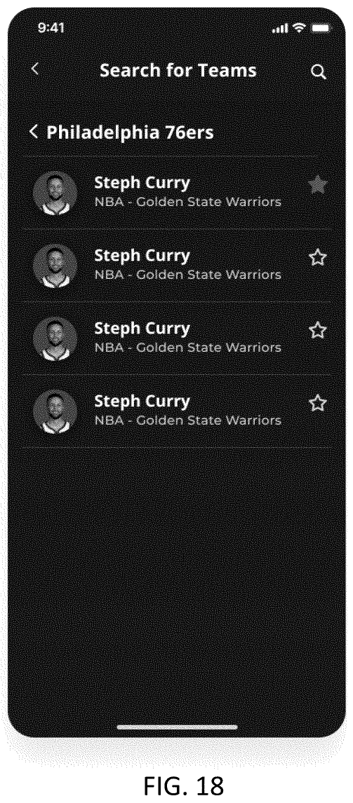

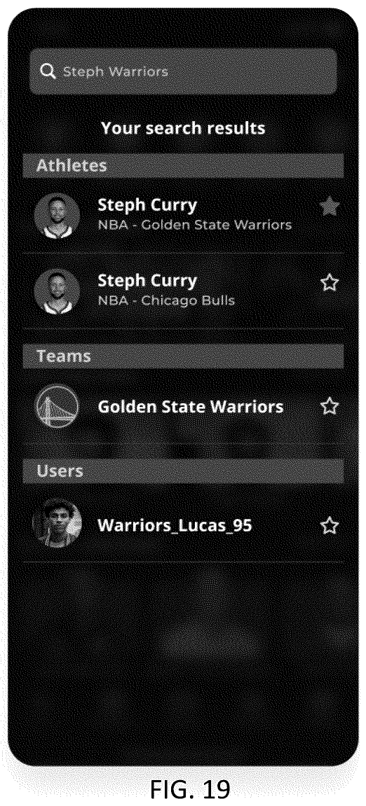

Referring to FIG. 17 an example screenshot of a user profile screen is shown. Users (i.e., fans) may have their own profile page. User(s) may search for a team using the team search screen (FIG. 18). FIG. 19 is an example screenshot of a search results window.

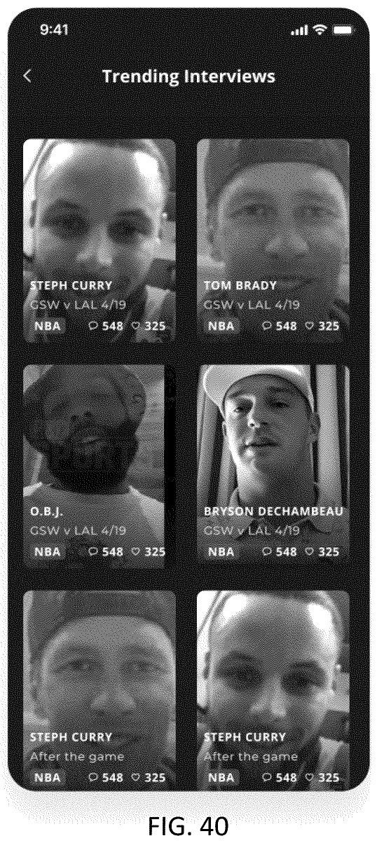

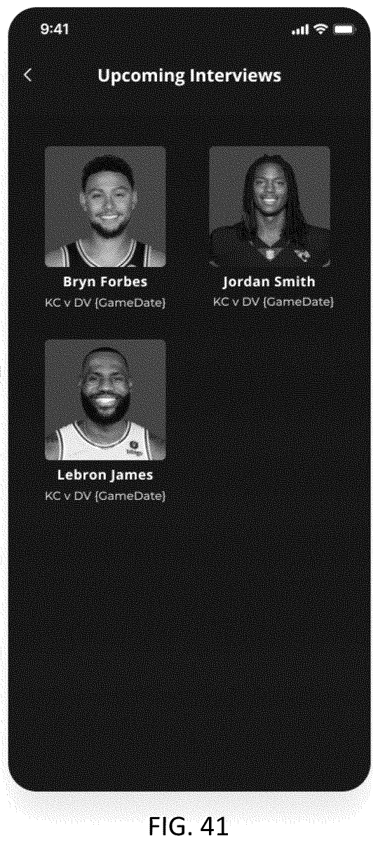

Referring to FIG. 40 an example screenshot of a trending interviews screen is shown. FIG. 41 shows an example screenshot of upcoming interviews.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an aspect,” “in aspects,” “in various aspects,” “in some aspects,” or “in other aspects” may each refer to one or more of the same or different aspects in accordance with this disclosure.

It should be understood that the description herein is only illustrative of this disclosure. Various alternatives and modifications can be devised by those skilled in the art without departing from the disclosure. Accordingly, this disclosure is intended to embrace all such alternatives, modifications, and variances. The aspects described are presented only to demonstrate certain examples of the disclosure. Other elements, steps, blocks, methods, and techniques that are insubstantially different from those described above and/or in the appended claims are also intended to be within the scope of the disclosure.

What is claimed is:

1. A system for real-time online user interaction with an athlete, comprising:
a processor; and
a memory, including instructions stored thereon, which, when executed by the processor, cause the system to:
access a plurality of questions;
generate a new question based on the plurality of questions;
access an end time of a sporting event;
determine if the sporting event has ended based on the end time; and
transmit the new question to the athlete in response to the sporting event ending.

2. The system of claim 1, wherein when generating a new question based on the plurality of questions, the instructions, when executed by the processor, further cause the system to:
receive as an input to a machine learning model the plurality of questions;
assign a first score, by the machine learning model to each question of the plurality of questions based on how related each of the plurality of questions are to one another;
generate, by the machine learning model, the new question based on a subset of the plurality of questions, where the subset includes questions that have a score over a threshold value; and
assign a second score to the new question based on how many questions of the plurality of questions make up the subset of the plurality of questions.

3. The system of claim 2, wherein in transmitting the new question to the athlete, the instructions, when executed by the processor, cause the system to:
transmit the new question to the athlete in response to the sporting event ending based on the second score.

4. The system of claim 2, wherein the machine learning model includes natural language processing.

5. The system of claim 1, wherein the instructions, when executed by the processor, further cause the system to:
filter the plurality of questions for profanity; and
remove questions from the plurality of questions that include profanity in response to the filtering.

6. The system of claim 1, wherein when generating a new question based on the plurality of questions, the instructions, when executed by the processor, further cause the system to:
group the plurality of questions into a plurality of sub-groups of questions that include a same topic relating to an athlete of the sporting event, where in the plurality of questions in each are topically related to one another; and
sort the plurality of groups of questions based on which of the plurality of groups of questions have a largest quantity of questions.

7. The system of claim 1, wherein the instructions, when executed by the processor, further cause the system to:
generate a new question based on the sub-group of questions that includes a largest quantity of questions to the athlete in response to the sporting event ending.

8. The system of claim 7, wherein the instructions, when executed by the processor, further cause the system to:
transmit the new question to the athlete in response to the sporting event ending and a number of votes.

9. The system of claim 6, wherein the instructions, when executed by the processor, further cause the system to:
receive a number of votes for each group of the plurality of groups of questions.

10. The system of claim 9, wherein the instructions, when executed by the processor, further cause the system to:
generate a new question based on the group of questions that includes a largest number of votes in response to the sporting event ending.

11. A computer-implemented method for real-time online user interaction with an athlete, the method comprising:
accessing a plurality of questions;
generating a new question based on the plurality of questions;
accessing an end time of a sporting event;
determining if the sporting event has ended based on the end time; and
transmitting the new question to the athlete in response to the sporting event ending.

12. The computer-implemented method of claim 11, further comprising:
receiving as an input to a machine learning model the plurality of questions;
assigning a first score, by the machine learning model to each question of the plurality of questions based on how related each of the plurality of questions are to one another;
generating by the machine learning model, the new question based on a subset of the plurality of questions, where the subset includes questions that have a score over a threshold value; and
assigning a second score to the new question based on how many questions of the plurality of questions make up the subset of the plurality of questions.

13. The computer-implemented method of claim 12, wherein transmitting the new question to the athlete comprises:
transmitting the new question to the athlete in response to the sporting event ending based on the second score.

14. The computer-implemented method of claim 12, wherein the machine learning model includes natural language processing.

15. The computer-implemented method of claim 11, further comprising:
filtering the plurality of questions for profanity; and
removing questions from the plurality of questions that include profanity in response to the filtering.

16. The computer-implemented method of claim 11, further comprising:
grouping the plurality of questions into a plurality of groups of questions that include a same topic relating to an athlete of the sporting event, wherein the plurality of questions in each are topically related to one another; and
sorting the plurality of groups of questions based on which of the plurality of groups of questions have a largest quantity of questions.

17. The computer-implemented method of claim 11, further comprising:
generating a new question based on the group of questions of the plurality of groups of questions that includes a largest quantity of questions to the athlete in response to the sporting event ending.

18. The computer-implemented method of claim 11, further comprising:
transmitting the new question to the athlete in response to the sporting event ending and a number of votes.

19. The computer-implemented method of claim 16, further comprising:
receiving a number of votes for each group of the plurality of groups of questions; and
generating a new question based on the group of questions that includes a largest number of votes to the athlete in response to the sporting event ending.

20. A system for real-time online user interaction with an athlete, comprising:
a processor; and
a memory, including instructions stored thereon, which, when executed by the processor, cause the system to:
access a bid from a plurality of users including a first user and a second user;
confirm plurality of users are authenticated users;
compare a first bid from the first user to a second bid of the second user to determine a winning user based on a larger of the first bid or the second bid;
transmit instructions for live interview and a link for an interview preparation video to the winning user;
transmit a prompt to request a question to be asked to the athlete;
receive the question to be asked to the athlete;
compare the question passes a set of rules;
in a case where the question fails the set of rules then provide an indication to the winning user that the question fails and repeat transmitting the prompt to request a new question to be asked to the athlete; and
in a case where the question passes the set of rules then:
provide an indication to the winning user that the question passes;
provide a link to enter a virtual interview room; and
start the live interview with the athlete.
